(19) United States
(12) Patent Application Publication
(10) Pub. No.: US 2015/0372582 A1
(43) Pub. Date: Dec. 24, 2015

(54) CONTROL OF A THREE-PHASE VOLTAGE CONVERTER IN UNBALANCED MODE

(71) Applicant: ALSTOM TECHNOLOGY LTD, Baden (CH)

(72) Inventor: Guillaume DE PREVILLE, ELANCOURT (FR)

(73) Assignee: ALSTOM TECHNOLOGY LTD, BADEN (CH)

(21) Appl. No.: 14/766,929

(22) PCT Filed: Feb. 13, 2014
(86) PCT No.: PCT/EP2014/052806

§ 371 Date: Aug. 10, 2015

(30) Foreign Application Priority Data
Feb. 15, 2013 (EP) 13155388.5

(51) Int. Cl. H02M 1/00

(52) U.S. Cl. CPC H02M 1/00; H02M 2001/0009

(57) ABSTRACT

A method of controlling current in a three-phase voltage converter operating in current imbalance mode, the method being:
determining a setpoint limit value for forward current (Idlim*) as a function of a current capacity of the converter (Ilim) and of forward balanced current (Id*);
determining a maximum reverse current value (Iimax) as a function of the determined forward current setpoint limit value (Idlim*) and such that the phase currents are at a maximum; and
determining a reverse current setpoint limit value (Iilim*) as a function of the maximum value of the reverse current (Iimax) and of a reverse balanced current (Ii*).

### TECHNICAL FIELD

In general manner, the present invention concerns three-phase voltage converters. More particularly, it concerns controlling three-phase voltage converters operating in current imbalance mode.

By way of example, the equipment concerned includes a three-phase power supply with an imbalanced load, a high-voltage shore connection (HVSC).

### STATE OF THE PRIOR ART

Voltage source converters (VSCs) having an intermediate voltage circuit are controlled so as to limit current.

Current limitation is conventionally done within a limit circle determined by the current capacity of the converter and defined in a complex plane.

However, the inventor has found that limiting current to the limit circle is not optimal when the converter is operating in imbalance mode.

In this event, the phase currents of the converter do not reach their respective limits. That leads to not being able to take advantage of the full capacity of the equipment. The inventor has found, experimentally, that loss of performance can reach 8% to 10% depending on the state of imbalance. The loss is measured by the difference between the current capacity per phase and the peak current obtained during limitation.

At constant performance, it would therefore be necessary to over-dimension the equipment in order to compensate for said loss of performance.

Document WO 2012/062327 concerns the operation of a power generation system coupled to a power grid during a grid fault event or a grid unbalance event.

Document US 2005/063205 relates to controlling a voltage converter.

Document US 2009/244937 concerns controlling an AC/DC PWM converter under unbalanced input voltage conditions.

### SUMMARY OF THE INVENTION

The invention aims to resolve the problems of the prior art by providing a method of controlling current in a three-phase voltage converter operating in current imbalance mode, the method being characterized in that it comprises the steps of:
determining a setpoint limit value for forward current as a function of a current capacity of the converter and of a forward balanced current;
determining a maximum reverse current value as a function of the determined forward current setpoint limit value and such that the phase currents are at a maximum; and
determining a reverse current setpoint limit value as a function of the maximum value of the reverse current and of a reverse balanced current.

By means of the invention, a new condition for current limitation is defined for a three-phase voltage converter operating in imbalance mode, making it possible to make maximum use of the current capacity of the converter.

According to the invention, the locus of the current in imbalance conditions is not the limit circle defined by the current capacity of the converter.

The current is limited phase by phase, in such a manner as to make full use of the current availabilities of the converter.

It is appropriate to determine firstly the setpoint limit value for forward current.

According to a preferred characteristic, the forward current setpoint limit value is determined as being equal to the current capacity of the converter if the forward balanced current has a value that is greater than the current capacity of the converter, or else as being equal to the forward balanced current.

Once the forward current setpoint limit value has been determined, action is taken on the reverse current.

According to another preferred characteristic, the maximum reverse current value is determined as being the minimum value of the respective maximum current values determined for each of the phases as a function of the forward current setpoint limit value.

According to another preferred characteristic, the reverse current setpoint limit value is determined as being equal to the maximum value of reverse current if the reverse balanced current has a value that is greater than the maximum value of the reverse current, or else as being equal to the reverse balanced current.

According to another preferred characteristic, the method of the invention further comprises the step of determining setpoint phase current values of the converter as a function of the forward current setpoint limit value and of the reverse current setpoint limit value.

The invention also provides a device for controlling current in a three-phase voltage converter operating in current imbalance mode, the device being characterized in that it comprises:
means for determining a setpoint limit value for forward current as a function of a current capacity of the converter and of forward balanced current;
means for determining a maximum reverse current value as a function of the determined forward current setpoint limit value and such that the phase currents are at a maximum; and
means for determining a reverse current setpoint limit value as a function of the maximum value of the reverse current and of a reverse balanced current.

The invention further provides a three-phase voltage converter, characterized in that it includes a control device as presented above.

The control device and the converter present advantages that are similar to those explained above.

In a particular implementation, the steps of the method of the invention are performed by computer program instructions.

Consequently, the invention also provides a computer program on a data medium, said program being suitable for running on a computer, said program including instructions for performing the steps of a method as described above.

The program may use any programming language, and may be in the form of source code, object code, or code intermediate between source code and object code, such as in a partially compiled form, or in any other desirable form.

The invention also provides a computer-readable data medium including computer program instructions for executing steps of the method as described above.

The data medium may be any entity or device capable of storing the program. By way of example, the data medium may comprise storage means, such as a read-only memory (ROM), e.g. a compact disk (CD) ROM, or a microelectronic ROM, or even magnetic recording means, e.g. a floppy disk or a hard disk.

In addition, the data medium may be a transmittable medium such as an electrical or optical signal suitable for being conveyed via an electrical or optical cable, by radio, or by other methods. The program of the invention may in particular be downloaded over an Internet type network.

Alternatively, the data medium may be an integrated circuit in which the program is incorporated, the circuit being adapted to execute or to be used in the execution of the method of the invention.

### BRIEF DESCRIPTION OF THE DRAWINGS

Other characteristics and advantages appear on reading the preferred embodiment given by way of non-limiting example, described with reference to the figures, in which:

FIG. 1 shows a device of the invention for controlling current in a three-phase voltage converter operating in current imbalance mode;

FIG. 2 shows an embodiment of the device of the invention; and

FIG. 3 shows an implementation of the method of the invention for controlling current in a three-phase voltage converter operating in current imbalance mode.

### DETAILED DESCRIPTION OF PARTICULAR EMBODIMENTS

Firstly, it is recalled that respective magnitudes relating to the phases of a three-phase system are equivalent to a space vector, which is a complex number.

The space vector contains all the information of the original three-phase system.

When the three-phase system is balanced, the space vector describes a circle in the complex plane. A disturbance, in particular such as an imbalance, causes the space vector, and consequently the circle, to deform, which deformation is visible in the complex plane.

Below, attention is given more particularly to the phase currents of an imbalanced three-phase system and consequently to the current space vector. The imbalanced three-phase system is composed of two balanced three-phase systems, one of which is forward and the other is reverse.

Consideration is given to reference or setpoint phase currents I1*, I2*, and I3* of a three-phase voltage converter. As a result of the above, these reference phase currents may be expressed as a function of a forward balanced current Id* and of a reverse balanced current Ii*, using the following relationships:

I1*(t)=Id*.cos(w.t)+Ii*.cos(w.t−phi)

I2*(t)=Id*.cos(w.t−2.π/3)+Ii*.cos(w.t−phi+2.π/3)

I3*(t)=Id*.cos(w.t−4.π/3)+Ii*.cos(w.t−phi+4.π/3)

in which phi is the phase offset of the reverse current relative to the forward current.

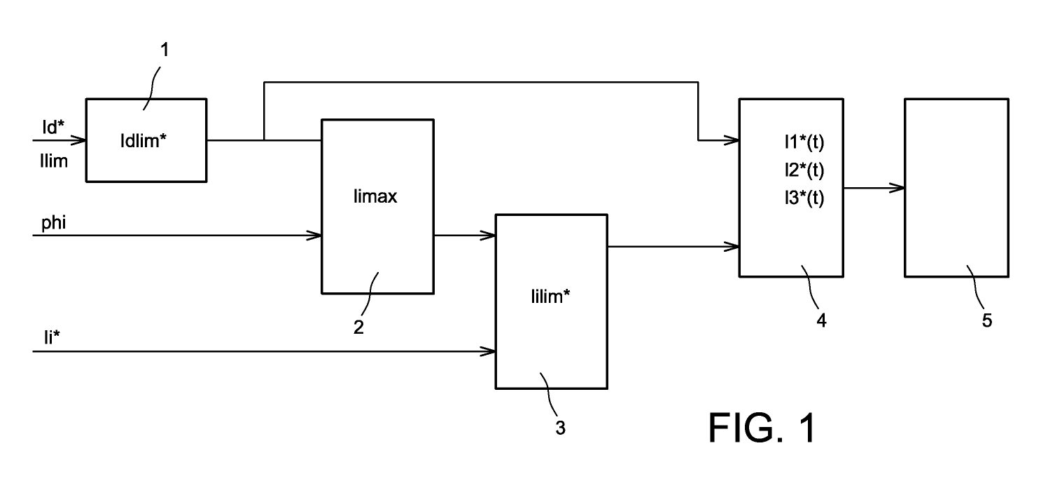

In an embodiment shown in FIG. 1, a current control device for a three-phase voltage converter operating in current imbalance mode includes a module 1 for determining a forward current setpoint limit value Idlim*. The module 1 includes an input interface that is suitable for receiving the value of the forward balanced current Id*.

The module 1 uses the value of the forward balanced current Id* in the following manner:
If the value of the forward balanced current Id* is greater than the value of the current capacity of the converter Ilim, then the forward current setpoint limit value Idlim* is equal to the value of the current capacity of the converter Ilim.

If the value of the forward balanced current Id* is less than the value of the current capacity of the converter Ilim, then the forward current setpoint limit value Idlim* is equal to the value of the forward balanced current Id*.

In other words, the forward current setpoint limit value Idlim* is equal to the smaller of the values of the current capacity Ilim of the converter and of the forward balanced current Id*.

The module 1 includes an output interface that is firstly connected to an input interface of a module 2 for determining a maximum reverse current value Iimax. The module 2 includes a second input interface that is suitable for receiving the phase offset phi between the forward current and the reverse current.

The module 1 transmits to the module 2 the forward current setpoint limit value Idlim* that it has determined.

The module 2 uses the forward current setpoint limit value Idlim* and the value of the phase offset phi in the following manner:

The module 2 firstly calculates a maximum reverse current value Iimax1, Iimax2, and Iimax3 for each phase, using the following formulas, expressed using a per-unit system:

Iimax1=−Idlim*.cos(phi)+{square root over (1−(Idlim*.sin(phi))²)}

Iimax2=−Idlim*.cos(phi+4.π/3)+{square root over (1−(Idlim*.sin(phi+4.π/3))²)}

Iimax1=−Idlim*.cos(phi+2.π/3)+{square root over (1−(Idlim*.sin(phi+4.π/3))²)}

The module 2 then determines the minimum value among the three calculated values Iimax1, Iimax2, and Iimax3. This minimum value is the maximum reverse current value Iimax1.

The module 2 includes an output interface that is connected to an input interface of a module 3 for determining a reverse current setpoint limit value Iilim* as a function of the maximum value of the reverse current Iimax and of the reverse balanced current Ii*. The module 2 provides the maximum reverse current value Iimax to the module 3.

The module 3 includes a second input interface that is suitable for receiving the value of the reverse balanced current Ii*.

The module 3 uses the maximum value of the reverse current Iimax and the value of the reverse balanced current Ii* in the following way:
If the value of the reverse balanced current Ii* is greater than the maximum reverse current value Iimax, then the reverse current setpoint limit value Iilim* is equal to the maximum reverse current value Iimax.

If the value of the reverse balanced current Ii* is less than the maximum reverse current value Iimax, then the reverse current setpoint limit value Iilim* is equal to the reverse balanced current value Ii*.

In other words, the reverse current setpoint limit value Iilim* is equal to the smaller of the values among the maximum value of the reverse current Iimax and the value of the reverse balanced current Ii*.

The module 3 includes an output interface that is connected to an input interface of a module 4 for determining setpoint phase current values of the converter as a function of the forward current setpoint limit value Idlim* and of the reverse current setpoint limit value Iilim*. The module 3 delivers the reverse current setpoint limit value Iilim* to the module 4.

The module 1 includes an output interface that is connected to an input interface of the module 4. The module 1 delivers the forward current setpoint limit value Idlim* to the module 4.

The module 4 uses the values that it receives to perform the following calculations in order to determine the setpoint phase current values I1*(t), I2*(t), and I3*(t):

I1*(t)=Idlim*.cos(w.t)+Iilim*.cos(w.t−phi)

I2*(t)=Idlim*.cos(w.t−2.π/3)+Iilim*.cos(w.t−phi+2.π/3)

I3*(t)=Idlim*.cos(w.t−4.π/3)+Iilim*.cos(w.t−phi+4.π/3)

The module 4 includes an output interface that is connected to an input interface of a voltage converter 5. The module 4 delivers the setpoint phase current values I1*(t), I2*(t), and I3*(t) to the converter 5. Said converter is conventional and is not described in detail here.

The control device, essentially comprising the modules 1, 2, 3, and 4, may be integrated into the converter 5, or on the contrary, may be an external device associated with the converter 5.

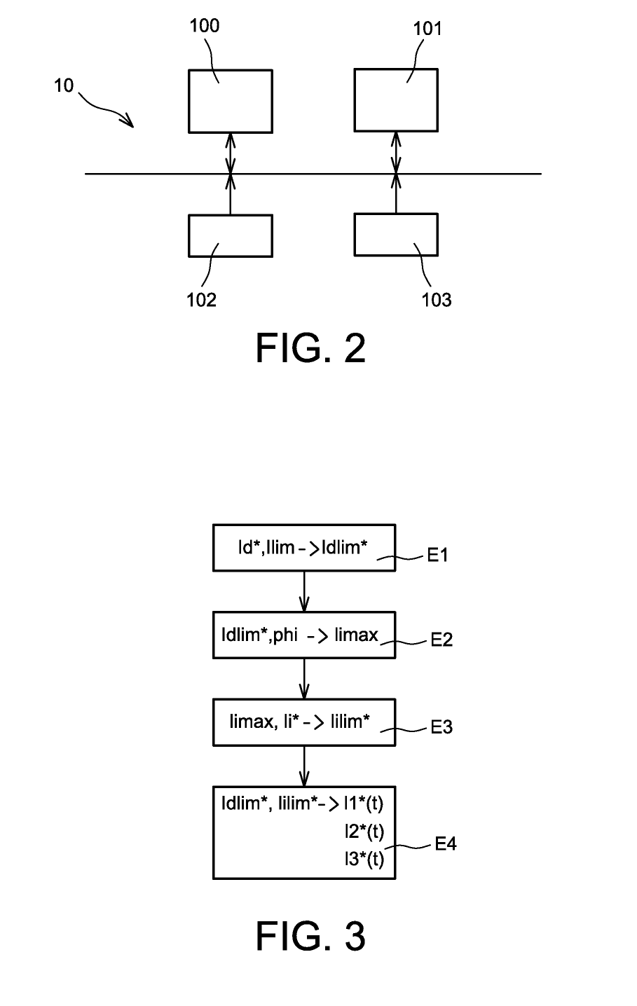

FIG. 2 shows a particular embodiment of the device of the invention.

The device 10 has the general structure of a computer. It includes a processor 100 executing a computer program implementing the method of the invention, a memory 101, an input interface 102, and an output interface 103 in order to apply the determined values as setpoint values of the converter.

These various elements are conventionally connected by a bus.

The input interface 102 is designed to receive the values for forward balanced current Id*, for reverse balanced current Ii* and for the phase offset phi of the reverse current relative to the forward current.

The processor 100 executes the processes explained above with reference to FIG. 1. These processes are implemented in the form of code instructions for the computer program that are stored in the memory 101 before being executed by the processor 100.

The memory 101 may further store the results of the processes performed.

The output interface 103 is connected to the converter in order to apply the determined values thereto as setpoint values.

With reference to FIG. 3, the current control method of the invention for a three-phase voltage converter operating in current imbalance mode, implemented by the above-described device, comprises the steps E1 to E4.

The step E1 involves determining the forward current setpoint limit value Idlim* as a function of the value of the forward balanced current Id* and of the value of the current capacity of the converter Ilim.

The forward current setpoint limit value Idlim* is equal to the smallest of the current capacity value Ilim of the converter and of the forward balanced current value Id*.

The following step E2 involves determining the maximum reverse current value Iimax as a function of the forward current setpoint limit value Idlim* and of the phase offset phi.

This step comprises calculating the value of the maximum reverse current Iimax1, Iimax2, and Iimax3 for each phase using the following formulas:

Iimax1=−Idlim*.cos(phi)+{square root over (1−(Idlim*.sin(phi))²)}

Iimax2=−Idlim*.cos(phi+4.π/3)+{square root over (1−(Idlim*.sin(phi+4.π/3))²)}

Iimax1=−Idlim*.cos(phi+2.π/3)+{square root over (1−(Idlim*.sin(phi+4.π/3))²)}

This step then includes determining the minimum value among the three calculated values Iimax1, Iimax2, and Iimax3. This minimum value is the maximum reverse current value Iimax.

The following step E3 is for determining the reverse current setpoint limit value Iilim* as a function of the maximum value of the reverse current Iimax and of the reverse balanced current value Ii*.

The reverse current setpoint limit value Iilim* is equal to the smallest of the values among the maximum reverse current value Iimax and the reverse balanced current value Ii*.

The following step E4 is for determining setpoint phase current values I1*(t), I2*(t) et I3*(t) of the converter as a function of the forward current setpoint limit value Idlim* and of the reverse current setpoint limit value Iilim*.

These values are determined according to the following formulas:

I1*(t)=Idlim*.cos(w.t)+Iilim*.cos(w.t−phi)

I2*(t)=Idlim*.cos(w.t−2.π/3)+Iilim*.cos(w.t−phi+2.π/3)

I3*(t)=Idlim*.cos(w.t−4.π/3)+Iilim*.cos(w.t−phi+4.π/3)

These current setpoint values are then applied to the converter.

1. A method of controlling current in a three-phase voltage converter operating in current imbalance mode, the method comprising: being characterized in that it comprises the steps of:
determining a forward current setpoint limit value (Idlim*) as a function of a current capacity of the converter (Ilim) and of a forward balanced current (Id*);
determining a maximum reverse current value (Iimax) as a function of the determined forward current setpoint limit value (Idlim*) and such that the phase currents are at a maximum; and
determining a reverse current setpoint limit value (Iilim*) as a function of the maximum value of the reverse current (Iimax) and of a reverse balanced current (Ii*).

2. A control method according to claim 1, wherein the forward current setpoint limit value (Idlim*) is determined as being equal to the current capacity of the converter (Ilim) if the forward balanced current (Id*) has a value that is greater than the current capacity of the converter (Ilim), or else as being equal to the forward balanced current (Id*).

3. A control method according to claim 1, wherein the maximum reverse current value (Iimax) is determined as being the minimum value of the respective maximum current values determined for each of the phases as a function of the forward current setpoint limit value (Idlim*).

4. A control method according to claim 1, wherein the reverse current setpoint limit value (Iilim*) is determined as being equal to the maximum value of reverse current (Iimax) if the reverse balanced current (Ii*) has a value that is greater than the maximum value of the reverse current (Iimax), or else as being equal to the reverse balanced current (Ii*).

5. A control method according to claim 1, further including the step of determining setpoint phase current values of the converter as a function of the forward current setpoint limit value (Idlim*) and of the reverse current setpoint limit value (Iilim*).

6. A device for controlling current in a three-phase voltage converter operating in current imbalance mode, the device comprising:
means for determining a forward current setpoint limit value (Idlim*) as a function of a current capacity of the converter (Ilim) and of a forward balanced current (Id*);
means for determining a maximum reverse current value (Iimax) as a function of the determined forward current setpoint limit value (Idlim*) and such that the phase currents are at a maximum; and
means for determining a reverse current setpoint limit value (Iilim*) as a function of the maximum value of the reverse current (Iimax) and of a reverse balanced current (Ii*).

7. A three-phase voltage converter comprising:
means for determining a forward current setpoint limit value (Idlim*) as a function of a current capacity of the converter (Ilim) and of a forward balanced current (Id*);
means for determining a maximum reverse current value (Iimax) as a function of the determined forward current setpoint limit value (Idlim*) and such that the phase currents are at a maximum; and
means for determining a reverse current setpoint limit value (Iilim*) as a function of the maximum value of the reverse current (Iimax) and of a reverse balanced current (Ii*).

8. (canceled)

9. A computer-readable recording medium, on which is recorded a computer program including instructions for executing steps of:
determining a forward current setpoint limit value (Idlim*) as a function of a current capacity of the converter (Ilim) and of a forward balanced current (Id*);
determining a maximum reverse current value (Iimax) as a function of the determined forward current setpoint limit value (Idlim*) and such that the phase currents are at a maximum; and
determining a reverse current setpoint limit value (Iilim*) as a function of the maximum value of the reverse current (Iimax) and of a reverse balanced current (Ii*).
